(19) United States
(12) Patent Application Publication
(10) Pub. No.: US 2023/0052868 A1
(43) Pub. Date: Feb. 16, 2023

(54) Method of creating an ambient light rejecting projection screen using multi-layer selective light wavelength absorption materials

(71) Applicant: Bassam Mohammed Balsheh, Spring, TX (US)

(72) Inventor: Bassam Mohammed Balsheh, Spring, TX (US)

(73) Assignee: Bassam Mohammed Balsheh, Spring, TX (US)

(21) Appl. No.: 17/816,740

(22) Filed: Aug. 2, 2022

Related U.S. Application Data
(60) Provisional application No. 63/230,282, filed on Aug. 6, 2021.

(51) Int. Cl. G03B 21/60; G02B 5/00

(52) U.S. Cl. CPC G03B 21/60; G02B 5/003

(57) ABSTRACT

Two groups of multilayer selective light wave absorbing materials, group (a) and group (b), where group (a) is applied on top of the surface of a projection screen or any surface on which colored videos or pictures can be projected on by a projector, where the multilayers of group (a) selectively absorb the visible light waves with wavelengths other than the RGB waves matching the RGB wave wavelengths projected by the projector, and where group (b) is applied on top of the transparent surfaces of windows and light fixtures present where the projector and the screen are placed or installed, where the multilayers of group (b) selectively absorb the visible light waves matching the RGB light waves projected by the projector. With group (b) absorbing the RGB waves of the ambient light on the transparent surface of the windows and the surface of the light fixtures, and the rest of the light waves of the ambient light being absorbed by group (a) on top of the projection screen or surface, the result is then no light waves reaching the surface of the projection screen or surface other than the projector's RGB. This means that without the projector light, the screen appears as a black screen with a high contrast ratio and high gain. (FIG. 3)

This invention presented herein shall be utilized for front and rear projection. In addition, group (a) multilayers can be used on LCD screens, including Switchable Glass and films, to enhance ambient light rejection and to help reduce the leaking light from the light source inside the LCD TVs. Group (a) multilayers can be used on the surface of LED screens to enhance ambient light rejection and can be used on the cover of mobile phone screens to improve visibility under bright light conditions.

### FIELD

G03B21/56 projection screens

The present invention generally relates to creating an ambient light rejecting projection screen using multilayer selective light wavelength absorption.

### BACKGROUND

In today's technology age, display screens have an essential role in our lives. Although projectors are advantageous in terms of being cheaper, portable, and usable almost everywhere, they have a major disadvantage due to their inability to provide clear and good quality images in bright environments. A projector screen's contrast and image quality deteriorate in bright light environments. Therefore, much effort has been put into eliminating or reducing the negative effect of bright ambient light on projection screen image quality for many years. Several solutions, which will be mentioned in detail below, have been put forward to solve this problem; still, none of them have been entirely sufficient to resolve this issue.

One of the solutions was the addition of light-absorbing particles like carbon black or black iron oxide to screens. The addition of black particles caused the absorption of not only ambient light but also the projector light, resulting in a darker screen and a narrower viewing angle.

Another solution was the use of a multichromatic mixture that reflects selected wavelengths other than the RGB spectrum in the screen's surface. However, in this method, the reflected ambient light still interferes with the projector light.

### SUMMARY

The multilayer selective light wavelength absorbing materials applied on projection screens absorb the unwanted light waves and enables the screens to be used for watching projected images and videos clearly in a bright environment. The solution presented herein absorbs (not reflects) only the unwanted segments of the ambient light spectrum while allowing the light emitted by the projector (RGB) to pass to the screen and to be reflected back to the viewer's eyes if the screen was a front projection screen or pass through the screen to the viewer's eyes if the screen was a rear projection screen.

The aim of this invention, which will increase the usage areas of projectors, is to obtain a more portable screen than an LCD or TV monitor while obtaining the image quality comparable to that of an LCD screen or TV monitor.

### BRIEF DESCRIPTION OF THE DRAWINGS

FIG. 1 is a schematic diagram illustrating the visible light wavelength absorbing layers that absorb all visible light wavelengths except the RGB light waves emitted from the projector, which pass to the screen. (Referred as the group (a) in claims)

FIG. 2 is a schematic diagram illustrating the visible light wavelength absorbing layers that absorb the wavelengths matching the ones emitted by the projector. Still, they allow the rest of the ambient light waves to pass into the room. (Referred as group (b) in claims)

FIG. 3 is a schematic diagram illustrating the visible light wavelength absorbing layers applied to the screen and the windows and light fixtures to obtain a black yet bright screen as the most effective solution.

FIG. 4 is a schematic diagram illustrating the visible light wavelength absorbing layers that absorb all visible light wavelengths except the RGB light waves emitted from the projector, which pass through the rear projection screen to the viewer's eyes.

### DETAILED DESCRIPTION

This disclosure generally relates to projection screens. The negative effect of ambient light on projection screens or surfaces narrows the usage areas of projector technology. The solution presented here for this problem differs from the previous solutions in that it is based on selectively absorbing the unwanted light in the environment rather than reflecting it. Previous solutions on this topic were focused on the reflection of unwanted ambient light by way of multi-chromic particles and therefore prevented ambient light from passing onto the coated substrate. Previous studies were mainly concerned with reflecting the ambient light's wavelengths, not absorbing them. Another aspect of our solution that distinguishes it from others is that it provides a solution that is based on the laws of optic physics to produce a black yet bright screen without needing any black particles or dyes to be added to the screen.

The projectors and the display screens emit mainly three colors: Red, Green, and Blue (RGB). The RGB light emitted by projectors and similar displays may be narrowed into three wavelengths ranges: 455-480 nm for blue, 500-560 nm for Green, and 610-640 nm for Red. In contrast, the visible light (ambient light) ranges from 350 to 800 nm. So, by absorbing the ambient light with a wavelength less than 455 nm while allowing the light with a wavelength ranging from 455 nm to 480 nm to pass (blue) and absorbing the light wavelength ranging from above 480 nm to less than 500 nm, while allowing the light with wavelengths ranging from 500 nm to 560 nm to pass (Green), and absorbing the light wavelengths ranging from above 560 nm to less than 610, while allowing the light wavelengths ranging from 610 nm to 640 nm to pass (red), and absorbing the light wavelengths above 640 nm, the unwanted ambient light is absorbed without affecting the projected light from the projectors.

The main principle of this invention is based on one way of applying the light wavelength absorbing layers on windows and light fixtures in the area where the projection system is installed. Those layers are designed and selected to absorb the light wavelengths coming from the windows or emitted from the light fixtures that match the projector's emitted light wave wavelengths. This invention applies to both front and rear projections.

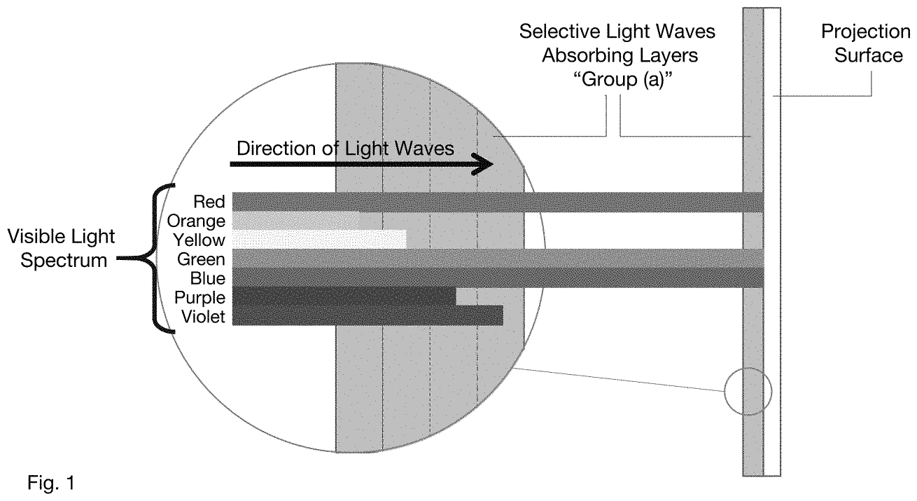

It is possible to divide the application into two groups for front projections. The first group of light wavelengths absorbing layers can be applied on the screen's surface, where those layers selectively absorb the ambient light wavelengths outside the wavelengths emitted from the projector. While the layers absorb the visible light spectrum, it allows the passage of RGB to the screen surface that is then reflected to the audience. (FIG. 1)

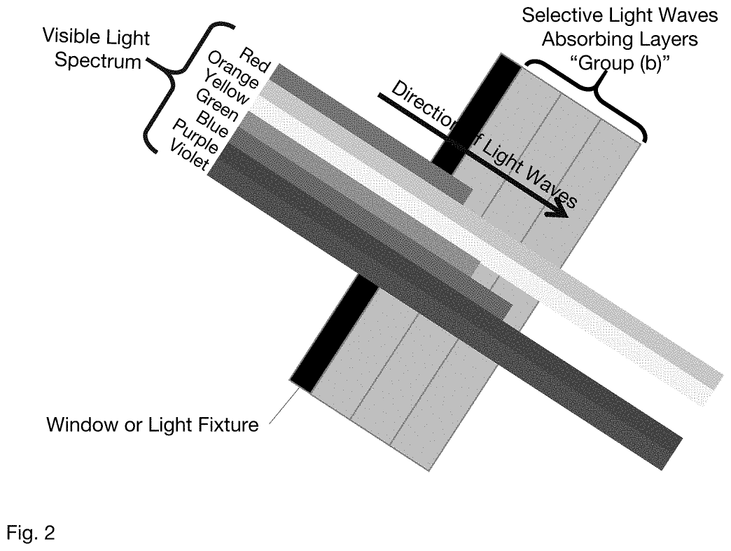

The second group of layers (group b) is applied to the windows or light fixtures in the area where the projector is located (FIG. 2) and consists of layers that absorb light waves with wavelengths matching the RGB waves emitted by the projector. The layers blocking RGB here will reduce the harmful interference of the ambient light coming from the windows and the light fixtures with the emitted light from the projector.

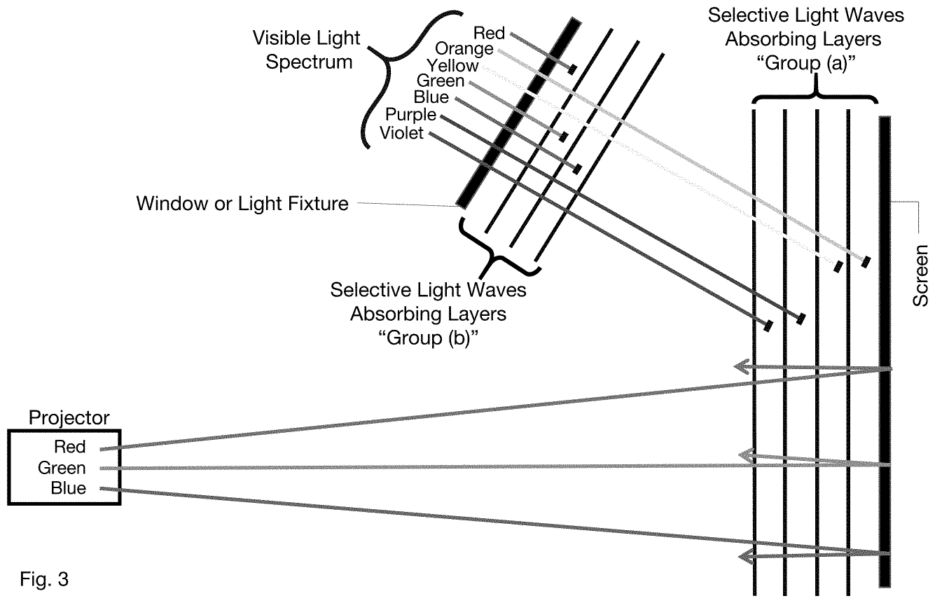

Light wave absorbing layers groups (a) and (b) when combined result in the highest efficiency as illustrated in (FIG. 3). This will result in maximum reduction of the effect of ambient light on the screen with minimal impact on the emitted wavelengths from the projector, resulting in a very high contrast ratio and a high gain. Applying the layers to the surface on which the projected light will be reflected and to the window glass from which the light enters from outside will absorb the unwanted RGB light waves in the ambient light. Thus, only the RGB emitted from the projector will reach the screen's surface and then be reflected to the eyes of the audience which results in a very high contrast ratio, high gain screen.

The application works for rear projection as well. The layers here, placed on the screen surface of the rear projection screen, absorb the unwanted ambient light waves while allowing the RGB light waves emitted by the projector to pass.

As understood herein, the selective light wave absorbing layers can optionally be applied to the surface to which the colored videos and pictures will be projected or to the windows where the light enters. They can be combined to obtain the best solution. This will result in a brighter screen, brighter colors, a better contrast ratio, better ambient light rejection, and no faded image on the screen. New projectors like laser projectors may have a much narrower wavelength range for each color in the “RGB” spectrum. The light wavelength absorbing layers can be adjusted based on the projected wavelengths from the projector.

Hereby, when the selective light wavelength absorbing layers are applied to the window's glass and the light fixtures in a room or an indoor space where the projection screen is placed, where those layers absorb the light wavelengths matching the light wavelengths emitted from the projector allowing all the other ambient light wavelengths to pass to the room environment, the remaining ambient light waves are absorbed by the selective light wavelength absorbing layers applied on the screen surface. In this scenario, there is no light reaching the screen's surface other than the projector's emitted light, which means that without the projector light, the screen will appear as a black screen. This effect significantly enhances the screen's contrast ratio, allowing the projection screens to match TV brightness and contrast ratio.

This invention is applicable to all screens, including microstructure screens like Fresnel lens and lenticular lens screens but with the freedom of how to position the screen and the projector. The microstructure screen can be flipped, and the projector can be mounted to the ceiling with no effect from the ceiling lights. One of the essential points of this invention is to eliminate the need to add black particles or gray scale particles and eliminate their negative effect on the screen's brightness.

The application presented here has many different uses. This invention can be used in LCD screens, including Switchable Glass and films, to enhance the ambient light rejection and help reduce the leaking light from the light source inside the LCD TVs. It is also possible to use this invention on the surface of LED screens to enhance ambient light rejection. Another area of use for this invention is the surface of mobile phone screens to improve visibility under bright light conditions like sunlight.

The light wavelength absorbing materials can be applied directly on top of any screen via spraying or coating methods or any other method that allows the formation of thin films of those materials. They can also be applied on glass or organic plastic films such as PET, PC, Acrylic, Styrene, PVC, VINYL, TPU, and other substrates. They can be applied on metal surfaces, wood, walls, and any surface used to project images or videos onto it.

The light wavelength absorbing materials can be used alone or added to resins. They can be water-based or solvent-based. They can be heat dried, ambient temperature dried, or UV cured.

It will be appreciated that whilst present principals have been described regarding some example embodiments, these are not intended to be limiting, and those various alternative arrangements may be used to implement the subject matter claimed herein.

REFERENCES CITED

| | | |
|---|---|---|
| 5111337 | May 1992 | Martinez |
| 5625489 | April 1997 | Glenn |
| 6529322 | March 2003 | Jones et al. |
| 6842282 | January 2005 | Kuroda et al. |
| 7072108 | July 2006 | Cruz-Uribe et al. |
| 7248406 | July 2007 | May et al. |
| 7535636 | May 2009 | Lippey et al. |
| 7733310 | June 2010 | Hajjar et al. |
| 7911693 | March 2011 | Smith et al. |
| 7974005 | July 2011 | Huibers et al. |
| 8218236 | July 2012 | Shiau et al. |
| 2007/013308 | June 2007 | Lippey |
| 2006/0209213 | September 2006 | Baker |
| 15/656691 | July 2017 | Dawson et al. |

I claim:

1. An assembly for frontal projection. A method has been developed to minimize the negative effect of ambient light on projector screens. The present invention comprises of two groups of light wave absorbing layers, which will be referred to as group (a) and group (b), wherein group (a) comprises of light wave absorbing layers that absorb the visible spectrum of light except for the light waves with wavelengths matching the light waves projected by the projector that is applied on a projection screen or any surface that can be used to project colored videos or pictures by a projector. (FIG. 1)
Group (b) comprises of light wave absorbing layers that absorb the light waves with wavelengths matching the wavelengths of light waves projected by the projector and applied on the transparent surfaces of the windows and the surfaces of the light fixtures in the area where the projector and the projector screen or surface are placed. (FIG. 2)

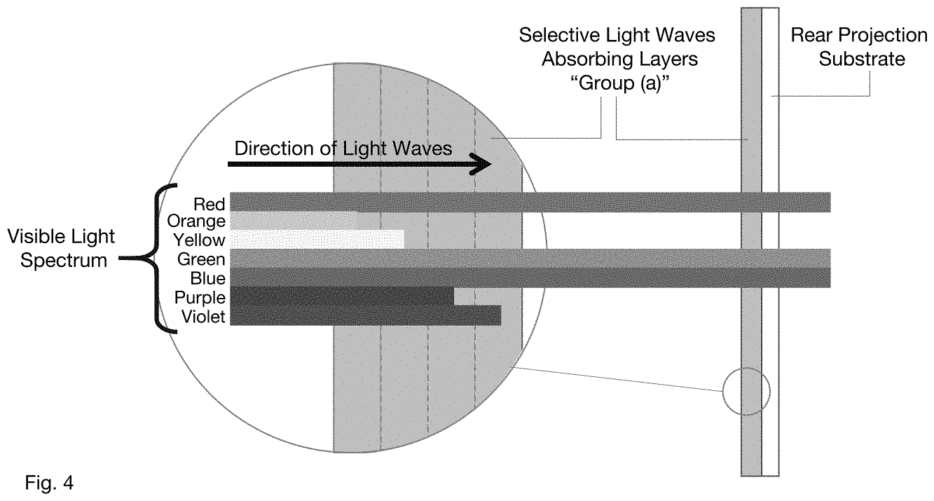

2. An assembly for rear projection that includes light wave absorbing layers that absorb the visible spectrum of light except for the light waves with wavelengths matching the light waves projected by the projector and applied on the rear projection screen surface. (FIG. 4)

3. The assembly of claim 1 wherein the light wave absorbing layers of group (a) comprise of a layer that absorbs light waves with wavelengths less than 450 nm.

4. The assembly of claim 1 wherein the light wave absorbing layers of group (a) comprising of a layer that absorbs light waves with wavelengths ranging from above 480nm to less than 500nm.

5. The assembly of claim 1 wherein the light wave absorbing layers of group (a) comprising of a layer that absorbs light waves with wavelengths ranging from above 560nm to less than 610nm.

6. The assembly of claim 1 wherein the light wave absorbing layers of group (a) comprising of a layer that absorbs light waves with wavelengths more than 640 nm.

7. The assembly of claim 1 wherein the light wave absorbing layers of groups (a) and (b) can be adjusted based on the wavelength of light waves projected by the projector.

8. The assembly of claim 1 wherein the light wave absorbing layers of group (b) comprising of a layer that absorbs light waves with a wavelength ranging from 450nm to 480nm.

9. The assembly of claim 1 wherein the light wave absorbing layers of group (b) comprising of a layer that absorbs light waves with a wavelength ranging from 500nm to 560nm,

10. The assembly of claim 1 wherein the light wave absorbing layers of group (b) comprising of a layer that absorbs light waves with a wavelength ranging from 610nm to 640nm.

11. The assembly of claim 2 wherein the light wave absorbing layers comprising of a layer that absorbs light waves with a wavelength less than 450 nm.

12. The assembly of claim 2 wherein the light wave absorbing layers comprising of a layer that absorbs light waves with a wavelength ranging from above 480nm to less than 500nm.

13. The assembly of claim 2 wherein the light wave absorbing layers comprising of a layer that absorbs light waves with a wavelength ranging from above 560nm to less than 610nm.

14. The assembly of claim 2 wherein the light wave absorbing layers comprising of a layer that absorbs light waves with a wavelength more than 640 nm.

15. The assembly of claim 1 wherein the light wave absorbing layers of groups (a) and (b) can be used together to produce a high contrast-high gain projection screen, and they can be used separately.

16. The assembly of claim 2 wherein the light wave absorbing layers can be adjusted based on the wavelength of light waves projected by the projector.
